(19) United States
(12) Patent Application Publication
(10) Pub. No.: US 2012/0015801 A1
(43) Pub. Date: Jan. 19, 2012

(54) PROCESS FOR PREPARATION OF A ZEOLITE-BASED CATALYST

(75) Inventors: Robert J. Deprez, Avon, NY (US); Dennis Roland Fronheiser, Rochester, NY (US)

(73) Assignee: Airflow Catalyst Systems, Rochester, NY (US)

(21) Appl. No.: 12/836,677

(22) Filed: Jul. 15, 2010

(51) Int. Cl. B01J 23/10

(52) U.S. Cl. 502/73

(57) ABSTRACT

Disclosed is a method for preparing a zeolite-based catalyst for application on a substrate. The method consists of the steps of: preparing a chemical composition comprising tin oxide, zirconium oxide, cerium oxide, and lanthanum oxide; combining the composition with a catalyst comprising a two-phase hydrocarbon NOₓ reduction catalyst comprising one or more transition metals supported on a molecular sieve with a coating of one or more stabilizing oxides; and applying the resulting catalyst material to a substrate. The ratio of the catalyst to chemical composition may vary from greater than 1 to 1 to less than 50 to 1. A washcoat may be prepared using the chemical composition, which washcoat is then combined with the catalyst. The washcoat may be combined with the zeolite catalyst using high power density mixing. The resulting catalyst material will then be applied to the substrate.

This disclosure relates to a process for preparing a zeolite-based catalyst. More particularly, this disclosure relates to preparing a zeolite-based catalyst using a catalytic material made of chemically-compatible materials to improve the ability to coat the zeolite-based catalyst on a substrate and improve its durability for use in conditions found in the exhaust of internal combustion engines.

### BACKGROUND OF THE INVENTION

The combustion of fossil fuels, such as gasoline or diesel fuel, leads to the formation of nitrogen oxides (NOₓ), among other harmful substances. Nitrogen oxides react with water to form nitric acid (HNO₃), which is a major contributor to acid rain. Nitrogen oxides can also detrimentally react with ozone. The United States and other jurisdictions have increasingly required NOₓ emission reductions from stationary and mobile sources. New technologies have been created to remove NOₓ from exhaust streams. For example, three-way catalysts have been developed to reduce NOₓ in the rich-burn exhaust found in automobiles. These catalysts, however, are not as effective in lean-bum conditions found in stationary sources of emissions or diesel vehicles. For stationary sources, ammonia may be used to reduce NOₓ. This method of reducing NOₓ is not preferred for mobile sources such as diesel vehicles because of the toxic nature of ammonia and the storage requirements. Further, the use of ammonia as a method of reducing NOₓ is hampered by the lack of availability. Unlike with regular gasoline or diesel fuel, there are few readily-available commercial sources of refueling and disposal for ammonia-based reductants.

Selective catalytic reduction (SCR) of NOₓ with hydrocarbons has been used under lean-burn conditions such as those found in diesel engines. Materials found to be catalytically active for SCR include metal-exchanged zeolites, such as Cu-ZSM-5, Co-ZSM-5 and Fe-ZSM-5. These zeolites are very active for SCR using C₃ hydrocarbons. These materials, however, lose much of their activity when water is added to the exhaust stream, which is common due to the presence of water in exhaust. Although the exact cause of the loss of activity due to the introduction of water is unknown, delumination of the zeolite framework may occur, reducing the number of active sites, or the metal sites may over-oxidize and lose their activity.

Marshall, et al., U.S. Pat. No. 7,220,692 (the “'692 Patent”), discloses a zeolite-based catalyst that demonstrates increased stability in water. Disclosed are bifunctional catalysts that combine active-metal exchanged molecular sieves with a separate metal oxide stabilizing phase forming an oxide coating thereon. The invention is in essence a two-phased catalyst comprising one or more transition metals supported on a molecular sieve and one or more stabilizing oxides coating the sieve material. The preferred embodiment of the invention disclosed in the '692 Patent is a catalyst composed of a zeolite-supported copper metal impregnated with a ceria stabilizing oxide. The claimed invention, however, can be comprised of any number of zeolite materials including zeolite Y, zeolite Beta, mordenite, ferrierite, ZSM-5 or ZSM-12.

As noted in the '692 Patent, any transition metal may be supported by the molecular sieve, including the commonly-used transition metals copper, cobalt, iron, silver, molybdenum, vanadium and combinations thereof. The supporting oxides that coat the molecular sieve material can be any one or more of the rare earth oxides such as cerium oxide and transition metal oxides, such as zirconium oxide, molybdenum oxide, vanadium oxide and niobium oxide. A preferred embodiment consists of cerium oxide alone or in combination with one or more of the other rare earth oxides. All of the preferred oxides are added in the form of metal oxide sols.

In using catalysts such as that disclosed the '692 Patent in industrial applications, standard practice is to disperse the zeolite-based material in water and coat it onto an appropriate catalytic substrate such as a ceramic monolith, or metallic wire, foil, or foam material. Coating the substrate with the catalyst is normally accomplished by means of various coating processes well-known in the industry which include, but are not limited to, curtain coating, spray coating, or immersion coating.

In order for the catalyst to be coated on the substrate, the zeolite material must remain uniformly dispersed in solution for a period of time of at least several minutes. Further, after drying, the material must adhere to the substrate for an extended period of time (several years) under conditions normally found in the exhaust system of an internal combustion engine. These conditions can include temperatures as high as 600° C., vibration, turbulent air flow, and exposure to moisture, hydrocarbons, and other products of combustion.

An inert material (often referred to as a “binder”) can be combined with the catalyst to facilitate this coating process and improve the performance of the resulting coated material. The binder must not have a detrimental effect on the catalyst or fill or block the internal space of the zeolite particles. Further, the binder must not react chemically with the active materials in the catalyst in a detrimental way (often referred to as “poisoning” the catalyst), during the preparation, application, or use of the catalyst materials. Ideally, the binder will facilitate the dispersion of the catalyst in water, and also the process of coating the catalyst onto a substrate. The combination of catalyst and binder materials must have the necessary adhesion and durability to survive the extreme conditions found in the exhaust system of an internal combustion engine. Further, using as little binder as possible is desirable in order to avoid unnecessary material costs and reduction in performance of the catalyst material.

The suitability of the catalyst described in the '692 Patent is hampered by its ability to be coated on a substrate. The zeolite materials disclosed in the '692 Patent do not disperse satisfactorily in water. Significant amounts of the catalyst material immediately sink to the bottom of the liquid. Further, the dispersal of the material is not significantly aided by aggressive stirring or standard dispersants or surfactants well-known within the industry. Likewise, the material cannot be milled, which is a common practice in the industry used in preparing materials that do not disperse in water. The milling process can crush the hollow zeolite particles, rendering them useless as a catalyst. Further, when the material is dispersed, it quickly separates, making it difficult to apply to substrates using standard industry methods. The material that can be applied despite these difficulties does not adhere well to typical catalytic substrates.

Finding a suitable binder to combine with the zeolite-based catalyst is also challenging because the zeolite material, alone, is difficult to disperse in water. Standard binders do not increase the ability to disperse the material or increase its adhesion. It is therefore apparent that binders typical for use in the industry are not suitable for use with the material disclosed in the '692 Patent. The catalyst disclosed in the '692 Patent therefore cannot be effectively used by itself as a catalyst in a typical engine, despite its ability to operate effectively in lean-burn conditions in the presence of water.

### BRIEF SUMMARY OF THE INVENTION

The present invention relates to a process for preparing a zeolite-based NOₓ reduction catalyst for application to typical catalytic substrates. It is an object of the invention to provide a suitable binder material for zeolite-based catalytic materials in order to allow their efficient use in the exhaust systems of internal combustion engines.

It is a further object of the invention to provide an appropriate method for preparing the zeolite-based catalyst materials to produce a liquid suitable for efficient application to catalytic substrates and to produce a robust material for use in exhaust systems of internal combustion engines.

The invention disclosed is a method for applying a zeolite-based catalyst to a substrate, comprising the steps of: (a) preparing a chemical composition comprising tin oxide, zirconium oxide, cerium oxide, and lanthanum oxide; (b) combining said chemical composition with a catalyst comprising a two-phase hydrocarbon NOₓ reduction catalyst comprising one or more transition metals supported on a molecular sieve and one or more stabilizing oxides coating the molecular sieve, wherein said oxide coating is substantially all and only on the exterior surface of said molecular sieve; and (c) applying the resulting catalyst material to a substrate. The molecular sieve claimed may consist of zeolite. In one embodiment of the invention, the ratio of catalyst to the chemical composition is greater than 1 to 1. In another embodiment, the ratio of catalyst to the chemical composition is less than 50 to 1.

Also disclosed is a method for applying a zeolite-based catalyst to a substrate, comprising the steps of: (a) preparing a washcoat with water and a chemical composition comprising tin oxide, zirconium oxide, cerium oxide, and lanthanum oxide; (b) combining said washcoat with a catalyst comprising a two phase hydrocarbon NOₓ reduction catalyst comprising one or more transition metals supported on a molecular sieve and one or more stabilizing oxides coating the molecular sieve, wherein said oxide coating is substantially all and only on the exterior surface of said molecular sieve; and (c) applying the resulting catalyst material to a substrate. The molecular sieve claimed may consist of zeolite. In one embodiment of the invention, the ratio of catalyst to the chemical composition is greater than 1 to 1. In another embodiment, the ratio of catalyst to the chemical composition is less than 50 to 1. The combining of the washcoat with the catalyst may be performed by high power density mixing.

In all of the claimed methods, the transition metal supported on the molecular sieve may include one or more of Cu, Co, Fe, Ag and Mo. Preferably, the transition metal may be Cu or Fe.

### DETAILED DESCRIPTION OF THE INVENTION

The present invention relates to a process for preparing a zeolite-based NOₓ reduction catalyst for application to typical catalytic substrates. As noted above, the zeolite-based catalyst disclosed in the '692 Patent is difficult to coat on a typical catalytic substrate using traditional methods.

Summers et al., U.S. Pat. No. 7,056,856 (the '856 Patent), describes a tin oxide catalyst employing precious metals. The material is a three-way tin-oxide based catalytic material that is stable at exhaust gas temperatures of internal combustion engines when the tin oxide lattice includes hafnium and/or any of several rare earth oxide components in the lanthanide series, such as oxides of La, Pr and Nd. The rare earth oxides replace or supplement the transition metal oxide promoters in prior art tin oxide catalysts. This replacement or supplementation provides a high degree of thermal stability as measured by the Brunauer/Emmett/Teller (BET) surface area in the range of temperatures required for automotive uses. Catalysts based on tin oxide and precious metals are well-known for use in low-temperature oxidation of carbon monoxide (CO) to carbon dioxide (CO₂) in only trace amounts of water.

The tin oxide material disclosed in the '856 Patent has been used with precious metal catalysts on a variety of catalytic substrates, including ceramic monoliths and metallic wire, foil, and foam materials. When dispersed in water, it is readily coated by methods commonly used in the catalytic products industry. The resulting product has the physical attributes desired in catalytic applications. The material remains adhered to the substrate and maintains its structure and performance characteristics over the expected lifetime of a catalytic element used in vehicular applications.

As noted above, the tin oxide material disclosed in the '856 Patent has been used as a three-way catalyst with precious metals. Due to its composition and structure, it would not be expected for the tin oxide material to aid in the dispersion of the zeolite-based catalyst in water. The zeolite catalyst, according to Stokes Law, has a particle size such that it should suspend in water by itself. Further, the use of a catalyst, such as the tin oxide material disclosed in the '856 Patent, as a binder is atypical. Most binders are chosen because they are inert and unlikely to react with the catalyst. Finally, as outlined below, the material had to .be combined using a method of mixing not common in the industry.

Nevertheless, the tin oxide material disclosed in the '856 Patent serves as a useful binder material for use with the zeolite-based catalysts described in the '692 Patent. The combination of these materials results in a liquid material suitable for manufacturing a catalytic element for use in internal combustion engine exhaust systems. The tin oxide material disclosed in the '856 Patent and the zeolite-based catalyst share some common constituents (zirconium oxide and rare-earth oxides), and so are chemically compatible with each other. Other materials commonly used as binders to be combined with catalytic materials are not chemically compatible with the zeolite-based catalyst and therefore can poison the catalyst or otherwise impede its function. Further, the liquid material resulting from the combination of the tin oxide support material and the catalyst is readily coated on a substrate by methods common in the industry. When dried, the material is durable under conditions normally found in the exhaust systems of internal combustion engines, and retains the catalytic activity of the catalyst material.

The catalytic performance of the zeolite-based catalyst is well-described in the '692 Patent. The performance disclosed is measured in a reactor, however, rather than as part of a catalytic element suitable for an exhaust system in an internal combustion engine. The catalyst by itself lacks many of the necessary physical characteristics to function in such a catalytic element such because it does not coat satisfactorily on the substrate and is not particularly durable. When the tin-oxide based material and zeolite catalyst are properly combined, however, the resulting material is readily coated by methods common in the industry. The resulting liquid dispersion has good stability and suspension characteristics, requiring only occasional stirring to maintain its properties during the application process. The combination of the tin-oxide based material and zeolite catalyst retains the catalytic activity of the zeolite material and is surprisingly more durable than one made with just the tin-oxide based material. The resulting catalytic coating should operate effectively in lean-burn conditions in the presence of water.

In preparing the combination of the tin-oxide based material and zeolite catalyst, it is preferable to first prepare a washcoat—type liquid from the tin oxide material. This material can be prepared by a variety of methods common in the industry. Surfactants and pH adjusters may be added to the tin oxide material to create an appropriate liquid for a specific substrate material and coating method. As is common in the industry, the ratio of the tin oxide material (which is being used as a binder) to water is selected for compatibility with the substrate material, desired coverage and/or coating method.

Once this tin oxide and water mixture is prepared, the zeolite catalyst material, additional water (if desired) and any additional minor substances added to improve its properties are combined. The relative amounts of washcoat solution, zeolite catalyst, water, and additional materials are selected depending on the nature of the substrate, the type of application method, and required catalyst coverage on the substrate. In combining these materials, standard mixing will not produce an optimum coating liquid because portions of the zeolite catalyst material will quickly settle to the bottom of the vessel. The mixture should be processed using high power density mixing. Through this mixing, the liquid mixture is violently agitated in the container. This mixing may be accomplished, for example, by using a mixer designed for a 25 to 50 gallon container with a 5 gallon container. As noted earlier, a milling process cannot be used because it will damage the zeolite material. The high power density mixing will result in a uniform suspension of the material for a sufficient amount of time for coating on the substrate in conformance with methods commonly used in the industry.

From the foregoing description, it will be apparent that there has been provided an improved method for preparing a zeolite-based catalyst. The increased ability to coat this material on a substrate and its increased durability once coated will facilitate its use as part of a catalytic element in an internal combustion engine. The resulting catalytic element will result in increased reduction of NOₓ emissions because of its ability to operate in lean-burn conditions common in diesel engines and other applications.

### EXAMPLE

One form of the catalyst described in Summers et al., U.S. Pat. No. 7,056,856, is AirFlow Catalyst Systems, Inc. Active-X. 3636.4 grams of a washcoat of 33% solids content of Active-X is placed in a 3½ gallon vessel. 3600 grams of the catalyst material described in Marshall et al., U.S. Pat. No. 7,220,692, such as in EXAMPLE 1 of the '692 Patent (Ce02/Cu-ZSM-5), is added along with 4763.6 grams of water. As is customary in the industry, surfactants or pH-adjusting materials may be added to achieve the desired coating properties. The material is mixed using a three-horsepower Arde Barinco CJ-20-1 mixer at top speed for 30 minutes. The resulting liquid is uniform in consistency, with no solid material evident in the bottom of the mixing vessel. If some settling of solid material occurs over extended periods of time (days), normal stirring with a standard lab mixer will bring the material back into suspension. The material may be coated on typical substrates according to methods commonly used in the industry.

What is claimed is:

1. A method for applying a zeolite-based catalyst to a substrate, comprising the steps of:
(a) Preparing a chemical composition comprising tin oxide, zirconium oxide, hafnium oxide, and lanthanum oxide;
(b) Combining said composition with a catalyst comprising a two phase hydrocarbon NOₓ reduction catalyst comprising one or more transition metals supported on a molecular sieve and one or more stabilizing oxides coating the molecular sieve, wherein said oxide coating is substantially all and only on the exterior surface of said molecular sieve; and
(c) Applying the resulting catalyst material to a substrate.

2. The method of claim 1 wherein the molecular sieve is zeolite.

3. The method of claim 2 wherein the ratio of catalyst to said chemical composition is greater than 1 to 1.

4. The method of claim 2 wherein the ratio of catalyst to said chemical composition is less than 50 to 1.

5. The method of claim 1 wherein the molecular sieve is zeolite and the transition metal includes one or more of Cu, Co, Fe, Ag and Mo.

6. The method of claim 5 wherein the ratio of catalyst to said chemical composition is greater than 1 to 1.

7. The method of claim 5 wherein the ratio of catalyst to said chemical composition is less than 50 to 1.

8. The method of claim 1 wherein the molecular sieve is zeolite and the transition metal is Cu.

9. The method of claim 8 wherein the ratio of catalyst to said chemical composition is greater than 1 to 1.

10. The method of claim 8 wherein the ratio of catalyst to said chemical composition is less than 50 to 1.

11. The method of claim 1 wherein the molecular sieve is zeolite and the transition metal is Fe.

12. The method of claim 11 wherein the ratio of catalyst to said chemical composition is greater than 1 to 1.

13. The method of claim 11 wherein the ratio of catalyst to said chemical composition is less than 50 to 1.

14. A method for applying a zeolite-based catalyst to a substrate, comprising the steps of:
(a) Preparing a washcoat with water and a chemical composition comprising tin oxide, zirconium oxide, cerium oxide, and lanthanum oxide;
(b) Combining said washcoat with a catalyst comprising a two phase hydrocarbon NOₓ reduction catalyst comprising one or more transition metals supported on a molecular sieve and one or more stabilizing oxides coating the molecular sieve, wherein said oxide coating is substantially all and only on the exterior surface of said molecular sieve; and
(c) Applying the resulting catalyst material to a substrate.

15. The method of claim 14 wherein the molecular sieve is zeolite.

16. The method of claim 15 wherein the ratio of catalyst to said chemical composition is greater than 1 to 1.

17. The method of claim 15 wherein the ratio of catalyst to said chemical composition is less than 50 to 1.

18. The method of claim 14 wherein the molecular sieve is zeolite and the transition metal includes one or more of Cu, Co, Fe, Ag and Mo.

19. The method of claim 18 wherein the ratio of catalyst to said chemical composition is greater than 1 to 1.

20. The method of claim 18 wherein the ratio of catalyst to said chemical composition is less than 50 to 1.

21. The method of claim 14 wherein the molecular sieve is zeolite and the transition metal is Cu.

22. The method of claim 21 wherein the ratio of catalyst to said chemical composition is greater than 1 to 1.

23. The method of claim 21 wherein the ratio of catalyst to said chemical composition is less than 50 to 1.

24. The method of claim 14 wherein the molecular sieve is zeolite and the transition metal is Fe.

25. The method of claim 24 wherein the ratio of catalyst to said chemical composition is greater than 1 to 1.

26. The method of claim 24 wherein the ratio of catalyst to said chemical composition is less than 50 to 1.

27. A method for applying a zeolite-based catalyst to a substrate, comprising the steps of:
(a) Preparing a washcoat with water and a chemical composition comprising tin oxide, zirconium oxide, cerium oxide, and lanthanum oxide;
(b) Combining said washcoat with a catalyst comprising a two phase hydrocarbon NOₓ reduction catalyst comprising one or more transition metals supported on a molecular sieve and one or more stabilizing oxides coating the molecular sieve, wherein said oxide coating is substantially all and only on the exterior surface of said molecular sieve, and wherein said combining is performed by high power density mixing; and
(c) Applying the resulting catalyst material to a substrate.

28. The method of claim 27 wherein the molecular sieve is zeolite.

29. The method of claim 28 wherein the ratio of catalyst to said chemical composition is greater than 1 to 1.

30. The method of claim 28 wherein the ratio of catalyst to said chemical composition is less than 50 to 1.

31. The method of claim 27 wherein the molecular sieve is zeolite and the transition metal includes one or more of Cu, Co, Fe, Ag and Mo.

32. The method of claim 31 wherein the ratio of catalyst to said chemical composition is greater than 1 to 1.

33. The method of claim 31 wherein the ratio of catalyst to said chemical composition is less than 50 to 1.

34. The method of claim 27 wherein the molecular sieve is zeolite and the transition metal is Cu.

35. The method of claim 34 wherein the ratio of catalyst to said chemical composition is greater than 1 to 1.

36. The method of claim 34 wherein the ratio of catalyst to said chemical composition is less than 50 to 1.

37. The method of claim 27 wherein the molecular sieve is zeolite and the transition metal is Fe.

38. The method of claim 37 wherein the ratio of catalyst to said chemical composition is greater than 1 to 1.

39. The method of claim 37 wherein the ratio of catalyst to said chemical composition is less than 50 to 1.
